(19) United States
(12) Patent Application Publication
(10) Pub. No.: US 2005/0135260 A1
(43) Pub. Date: Jun. 23, 2005

(54) Publish/subscribe system

(75) Inventor: Stephen J. Todd, Winchester (GB)

Correspondence Address: IBM Corporation;IP Law Department, 11400 Burnet Road, Austin, TX, 78758, US

(73) Assignee: International Business Machines Corporation, Armonk, NY (US)

(21) Appl. No.: 10/992,487

(22) Filed: Nov. 18, 2004

(30) Foreign Application Priority Data
Dec. 17, 2003 (GB) 0329188.7

(51) Int. Cl. H04L 12/26

(52) U.S. Cl. 370/241

(57) ABSTRACT

A publish/subscribe system and method are provided. Each subscriber registers its event selection criterion with a message sender, which may be a publisher or a publishing broker for example, and the message sender allocates a signature bit pattern to each subscriber. When the message sender has an event to publish, it first selects those of its registered subscribers which have selection criteria which match the event. It then produces an encoded set of the signatures of the selected subscribers and sends a message identifying the event and the encoded signature set to each of its registered subscribers. Each subscriber determines whether the encoded set corresponds correctly to its signature bit pattern, and dependent on the correspondence or not of the subscriber's signature bit pattern, verifies whether the event matches its selection criteria and, if it matches, processes the event. The encoded set of signatures of selected subscribers is a combination of the signature bit patterns of each of the selected subscribers. The size of the message header needed is significantly reduced and at the same time most subscribers are able to discover whether an event is not for them in a single operation.

### BACKGROUND OF THE INVENTION

The present invention relates to data transmission in data processing systems and in particular to a publish/subscribe system.

Publish/subscribe systems deliver information over a computer network, typically from one data processing system to many others. These publish/subscribe systems can operate in a number of ways. The most basic system is one in which the sender matches a message against all known subscribers and sends the message individually to each subscriber. However, when there are a large number of subscribers, a large number of messages must be sent.

In an alternative, the sender broadcasts or multicasts a single message to all potential subscribers. Each potential subscriber then filters the message by checking whether the message matches its specific subscription. If the message passes the test, the subscriber processes the message, else the message is discarded. This system means that only one message needs to be sent by the sender. However, it is inefficient in that all subscribers have to carry out the matching check on all received messages, including those which are not ultimately interested in the message and as all subscribers receive the event valuable network bandwidth is consumed.

One approach to addressing this problem has been to require subscribers to register interest in future information and specify certain selection criterion. Senders can then use the registered selection criterion to produce a distribution list of subscribers for which the selection criterion is fulfilled. The sender then produces a single message including a distribution list header. This message is then widely distributed to all potential subscribers. Each subscriber can easily detect whether the message is of interest, by simply checking the distribution list header for its identity. If the potential subscriber finds it is identified in the distribution list header it will process the message. Thus the matching is done by the sender and each subscriber need only check for its ID in the header, rather than perform a full matching determination on the message.

The distribution list may take various forms. For example, it may include a bit pattern in which each bit represents a different subscriber, with bits set for each subscriber for which the matching criteria are fulfilled. The subscribers can then simply test their bit in the bit pattern and know that if their bit is set, then the message matches its criteria and should be processed. However, this technique is unwieldy when there are a large number of subscribers, as then the header, which has one bit per subscriber, becomes too long.

In an alternative, the header may simply list IDs for those subscribers for which the criteria matches. This can mean that the header is shorter when there are only a few matching subscribers, but if there are a large number of matching subscribers the header again becomes too big.

Further possibilities between these two extremes use standard compression techniques such as run-length encoding, where long series of identical bits are omitted, and which are well known in the compression art. Using these techniques, when a subscriber receives a message the subscriber can quickly tell whether the message is relevant without having to carry out a matching check, however the distribution list header included in the message can still be too large.

There is a need for an improved method and system which addresses these problems.

### SUMMARY OF THE INVENTION

According to a first aspect of the invention, there is provided a method of delivering a published event to a subscriber, the subscriber having a signature bit pattern and one or more criterion for selecting a published event. The method comprises receiving a message identifying an event and an encoded set of subscriber signatures, determining whether the encoded set corresponds correctly to the signature bit pattern of the subscriber, and dependent on the correspondence or not of the subscriber's signature bit pattern, verifying whether the event matches some or all of the selection criterion of the subscriber and if it matches, the subscriber processing the event.

Typically each subscriber registers its event selection criterion with a message sender, which may be a publisher or a publishing broker for example, and the message sender allocates a signature bit pattern to each subscriber. When the message sender has an event to publish, it first selects those of its registered subscribers which have selection criteria which match the event. It then produces an encoded set of the signatures of the selected subscribers and publishes the event by sending a message identifying the event and including the encoded signature set to each of its registered subscribers.

The set of signatures of selected subscribers is encoded using a form of lossy compression to produce a ‘fuzzy’ signature. This is a combination of the signature bit patterns of each of the selected subscribers. Preferably, a plurality of M-bit signatures is combined together into an M-bit fuzzy signature. By using a fuzzy signature, the size of the header is significantly reduced and at the same time most subscribers are able to discover whether an event is not for them in a cheap, single step by a simple operation on the fuzzy signature. Subscribers for whom the event appears to be relevant from analysis of the fuzzy signature must then carry out a second step to verify whether the event does match their selection criteria. A small number of subscribers will find, having done this verification step that the event does not match their selection criteria, but most subscribers will have been able to see that the event was irrelevant using the fuzzy signature.

According to a second aspect of the invention, there is provided a message delivery mechanism for a system comprising a plurality of subscribers each having a signature bit pattern and one or more criterion for selecting a published event for processing. The mechanism is operable to receive a message identifying an event and an encoded set of subscriber signatures and determine whether the encoded set of signatures corresponds correctly to the signature bit pattern of one or more subscribers. Dependent on the correspondence or not of the encoded set and the signature bit pattern of a subscriber, the mechanism verifies whether the event matches the or each selection criterion of the relevant subscriber, and if it matches, the subscriber processes the event.

According to a further aspect of the invention, there is provided an event publishing mechanism for a system comprising a plurality of subscribers each having a signature bit pattern and one or more criterion for selecting a published event for processing. The mechanism is operable to select those subscribers for which the event matches some or all event selection criterion, combine the set of signature bit patterns of the selected subscribers into an encoded signature set, and send a message to the subscribers identifying the event and the encoded signature set.

### BRIEF DESCRIPTION OF THE DRAWINGS

Embodiments of the present invention will now be described by way of example only, with reference to the accompanying drawings in which:

FIG. 1 shows a schematic representation of a network of data processing systems according to an embodiment of the present invention;

FIG. 2 shows a sender and a plurality of subscribers according to an embodiment of the invention;

FIG. 3 shows a flowchart of the steps taken by a sender according to one embodiment of the invention;

FIG. 4 shows a flowchart of the steps taken on receipt of a message, according to one embodiment of the invention;

FIG. 5 shows more detail of the steps taken to test a received message, according to one embodiment of the invention; and

FIG. 6 shows an example of a fan-out distribution according to an embodiment of the invention.

### DESCRIPTION OF PARTICULAR EMBODIMENTS

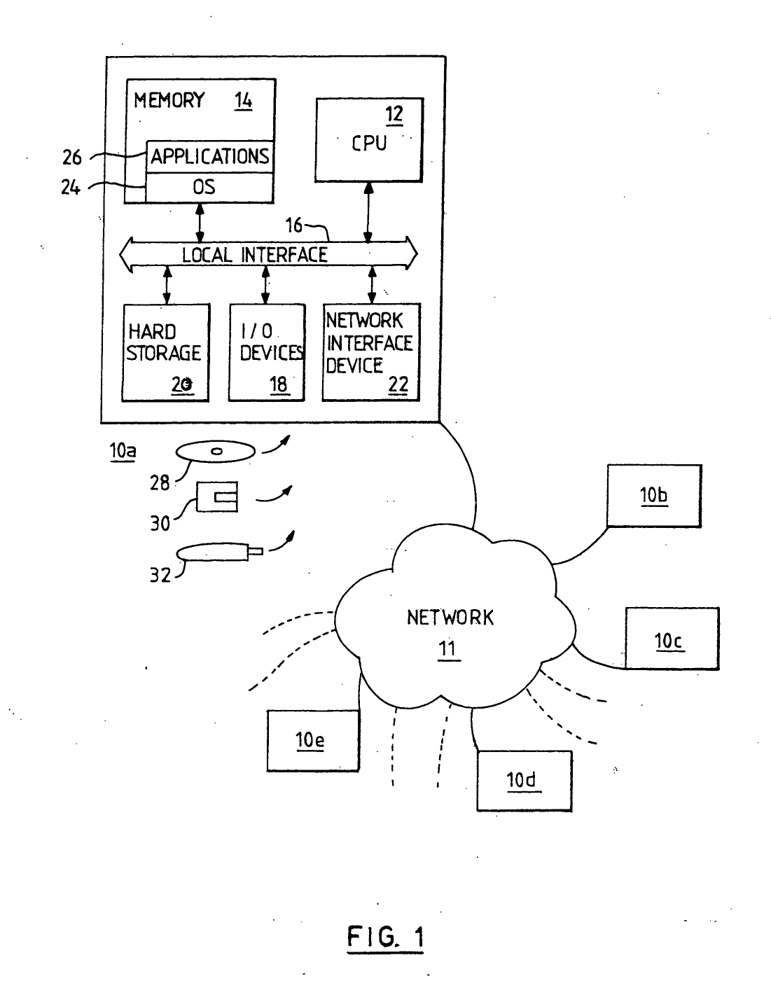

Referring to FIG. 1, there is illustrated a schematic representation of a network 11 of data processing systems, such as the Internet, comprising a plurality of data processing systems 10a, 10b . . . 10n. FIG. 1 shows a simplified representation of the typical components of data processing system 10a, which include a processor (CPU) 12, and memory 14 coupled to a local interface 16. One or more user-input devices 18 are connected to the local interface 16. Additionally, hard storage 20 and a network interface device 22 are provided.

Illustrated in FIG. 1, within memory 14 is operating system (OS) 24 and applications 26. Applications 26 refer to processes being currently run on the data processing system 10. The OS is a software (or firmware) component of the data processing system 10 which provides an environment for the execution of programs by providing specific services to the programs including loading the programs into memory and running the programs. The OS also manages the sharing of internal memory among multiple applications and/or processes and handles input and output control, file and data management, communication control and related services. Application programs make requests for services to the OS through an application program interface (not shown).

The data processing systems 10a, . . . 10n may comprise, for example, personal computers (PCs), laptops, servers, workstations, or portable computing devices, such as personal digital assistants (PDAs), mobile telephones or the like. Furthermore, data processing systems 10a, . . . 10n may comprise additional components not illustrated in FIG. 1, and, in other embodiments, may not include all of the components illustrated in FIG. 1.

Network interface device 22 may be any device configured to interface between the data processing system 10a and a computer network, such as a Local Area Network (LAN) or private computer network, or between the data processing system 10a and a telecommunications network, such as a public or private packet-switched or other data network including the Internet, a circuit switched network, or a wireless network.

A computer program for implementing various functions or for conveying information may be supplied on carrier media such as one or more DVD/CD-ROMs 28 and/or floppy disks 30 and/or USB memory device 32 and then stored on a hard disk, for example.

A program implementable by a data processing system may also be supplied on a telecommunications medium, for example over a telecommunications network and/or the Internet, and embodied as an electronic signal. For a data processing system operating as a wireless terminal over a radio telephone network, the telecommunications medium may be a radio frequency carrier wave carrying suitable encoded signals representing the computer program and data. Optionally, the carrier wave may be an optical carrier wave for an optical fibre link or any other suitable carrier medium for a telecommunications system.

In a publish/subscribe system according to an embodiment of the invention, one or more applications running on a data processing system 10a publish information in the form of ‘events’ and a plurality of applications running on one or more of the data processing systems 10a, . . . 10n register as subscribers to receive published information.

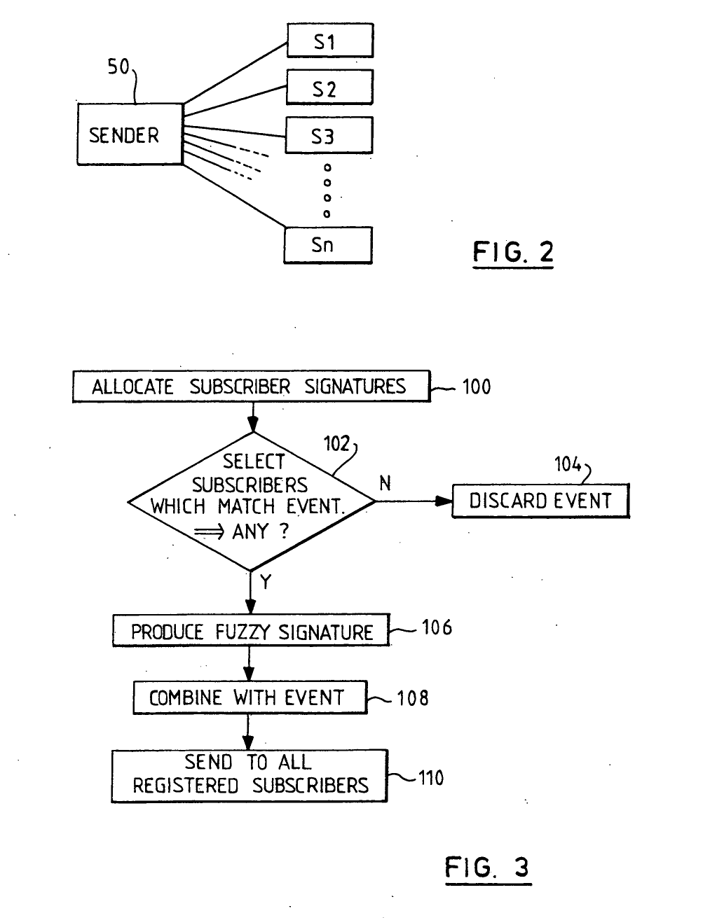

Let us consider the case of a sender 50 and a plurality of N subscribers, S1, S2 . . . SN, as shown in FIG. 2. The sender 50 may be a publisher, publishing broker, or proxy broker for example and the subscribers may include, for example, subscriber applications, subscriber clients, brokers or proxy brokers.

Each subscriber registers with the sender and may also register one or more event selection criterion. Referring to FIG. 3, the sender 50 allocates 100 a signature bit pattern sig(S) for each subscriber. The signature is an M-bit bit pattern (preferably with M much less than N to enjoy the maximum advantage of this method). Typically sig(S) will have just a small number, K, of bits set and these could be allocated randomly, but preferably these are allocated in dependence on the registered event selection criteria. Sig(S) need not be unique for each subscriber and could even have no bits set for some subscribers.

When the sender 50 has an event to publish, it carries out testing code 102 to select those subscribers for which the event is relevant. Several methods for matching events with subscribers are known in the prior art and may be used in embodiments of the present invention, for example, the methods disclosed in U.S. Pat. Nos. 6,216,312, 6,091,724 and 6,336,119, all issued to IBM Corporation. Typically, events are filtered based on topics, subjects or the content contained therein.

If the sender has no registered subscribers for which the event is relevant, the event is simply discarded 104. Otherwise, the sender encodes the set of signatures of selected subscribers by preparing 106 a ‘fuzzy’ signature for the selected subscribers. This is a bit pattern F which is the bitwise INCLUSIVE OR logic operation on the signature bit patterns of each of the selected subscribers. For example, suppose the sender allocates S1, S2 and S3 the following 8-bit signature bit patterns:
sig(S1)=1000 1000
sig(S2)=0100 0100
sig(S3)=1000 0100

If subscribers S2 and S3 are selected subscribers the fuzzy signature F(S2,S3) is

F(S2, S3)=0100 0100 (bitwise OR) 1000 0100=1100 0100.

So the bit pattern 1100 0100 is a fuzzy signature representing the encoded set of signatures of the selected subscribers, S2 and S3.

The sender then produces a message which combines 108 the fuzzy signature with the event being published, and then sends 110 this message to all its subscribers S1, . . . , SN.

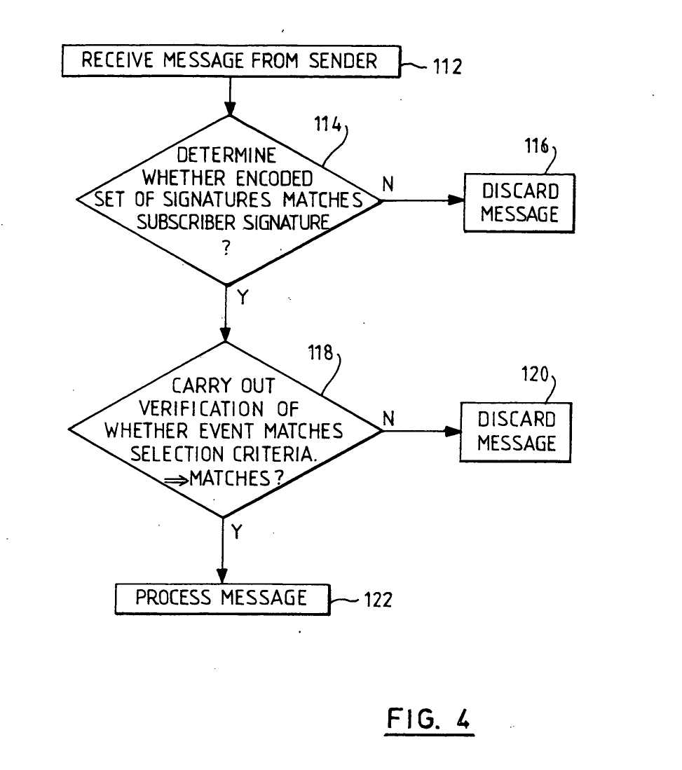

FIG. 4 shows an example of the steps taken on receipt 112 of the message from the sender. Each receiver determines 114 whether the received fuzzy signature corresponds correctly to its own subscriber signature. If the receiver has a plurality of subscribers it will check whether the fuzzy signature corresponds correctly to any of its subscribers' signatures. The step of determining this correspondence comprises checking that every bit which is set in its own signature is also set in the fuzzy signature. If not all bits which are set in its signature are also set in the fuzzy signature the receiver knows that the event is not relevant and discards the message 116. If all the bits set in its subscriber signature are set in the fuzzy signature, the receiver carries out precise testing code to verify 118 whether the event matches its subscriber event selection criteria. A small number of receivers will at this stage find that the event does not actually match their event selection criteria and so will discard the message 120. Most receivers who find that the fuzzy signature corresponds correctly will find that the subscriber's event selection criteria are fulfilled and so will proceed to process 122 the message.

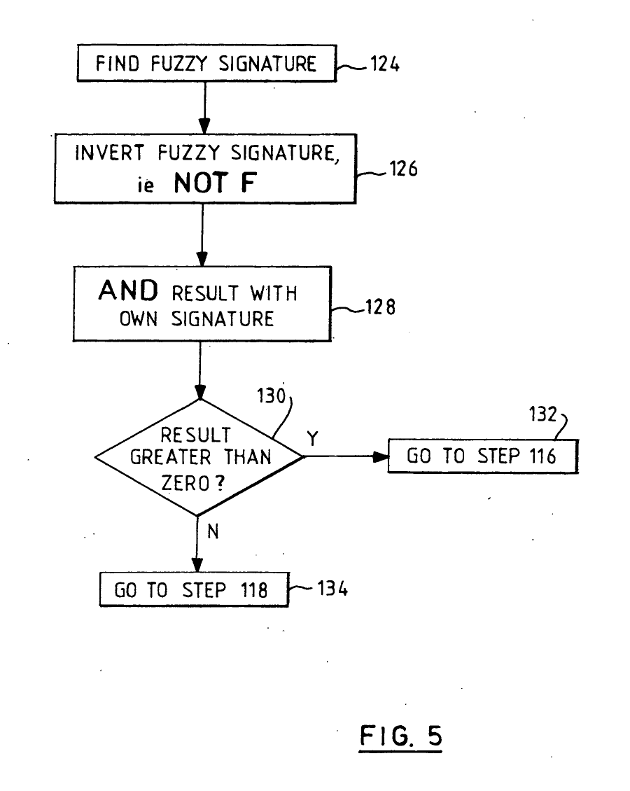

An example of a method by which the receivers/subscribers may check correspondence between their signatures and the fuzzy signature will now be explained with reference to FIG. 5. Suppose the signatures for subscribers S1, S2 and S3 are the same as those given above. If S2 and S3 are the selected subscribers, the fuzzy signature F(S2,S3), shortened hereafter to F23, may be included in the received message, as detailed above. To check correspondence, each subscriber S1, S2 and S3 pulls 124 the fuzzy signature from the message and carries out 126 the bitwise logical operation NOT on the fuzzy signature and then ANDs 128 the result, !F23, with its own signature:
sig(S1)=1000 1000
sig(S2)=0100 0100
sig(S3)=1000 0100
F23=1100 0100
!F23=0011 1011

In a modification, the sender calculates !F23 and includes this, rather than F23, in the message so that the subscribers do not have to carry out the inversion operation.

Carrying out the ‘fuzzy test’:
for S1: sig(S1) AND !F23=0000 1000->true negative
for S2: sig(S2) AND !F23=0000 0000->true positive
for S3: sig(S3) AND !F23=0000 0000->true positive

Each subscriber checks 130 whether the result of the fuzzy test is greater than zero. A zero result indicates a positive result, that is that the message may match that subscriber, and a non-zero indicates a negative result, that is that the message may be discarded. S1 correctly ascertains that the message is not relevant to it and so it will discard it. S2 and S3 correctly ascertain that the message is relevant to them, but each of them will still carry out precise testing to verify this.

The fuzzy test of this embodiment never returns false negatives and thus when the fuzzy test results in a negative result, the subscriber may immediately ignore the message without needing to do any further checking. The fuzzy test may sometimes return a false positive, and this is why subscribers carry out a verification step in the event of a positive return at the fuzzy test stage.

Now consider a message which matches the selection criteria of subscribers S1 and S2. The message sent from the sender may include the fuzzy signature F12 or !F12 where:
F12=1100 1100
!F12=0011 0011

When subscribers S1, S2 and S3 carry out the ‘fuzzy test’:
for S1: sig(S1) AND !F12=0000 0000->true positive
for S2: sig(S2) AND !F12=0000 0000->true positive
for S3: sig(S3) AND !F12=0000 0000->false positive

The false positive for testing S3 occurs because all set bits in sig(S3) happen to be set in either sig(S1) or sig(S2).

As will be appreciated by those skilled in the art, there are various methods by which subscriber bit patterns could be encoded, the fuzzy test could be carried out, or the sender could determine the subscribers to which an event relates. If the size, M, of the signatures, sig(S), is reasonably small (say 64), it is probably best to encode sig(S) directly as a bitmap and implement the functions using pseudo-code. For larger values of M, it might be better to encode sig(S) as a list of set bits and to use a loop function to verify each set bit.

Standard statistics can be used to work out the probability of returning a false positive, given M, K and the number of elements in a given subscriber list. This probability does not depend on the total population size N. The number of false positives will be proportional to the population size, but the work of coping with the extra tests due to the false positives will be distributed between the larger number N of potential subscribers.

Where there is known correlation between the subscriptions of two subscribers, it is beneficial for them to be given related signatures (eg sharing some set bits). This reduces the size of their combined signature, and reduces the risk of their combination contributing to a false positive.

Where one subscriber is known to receive a larger proportion of publications, it is preferably given a shorter signature, that is have a smaller number K of bits set. The number of bits that should be set depends on the logarithm of the proportion of publications that match the subscription, and on the relative costs of (a) transmitting and processing longer headers, and (b) processing false positives. In particular, a subscriber that receives all publications should have zero bits set in its signature.

The sender can use statistical analysis of subscription correlations and probabilities to define the signature bit patterns, which may also be termed ‘keys’. Statistics on subscription correlations and probabilities could be maintained by the sender and the sender could periodically reallocate optimized keys.

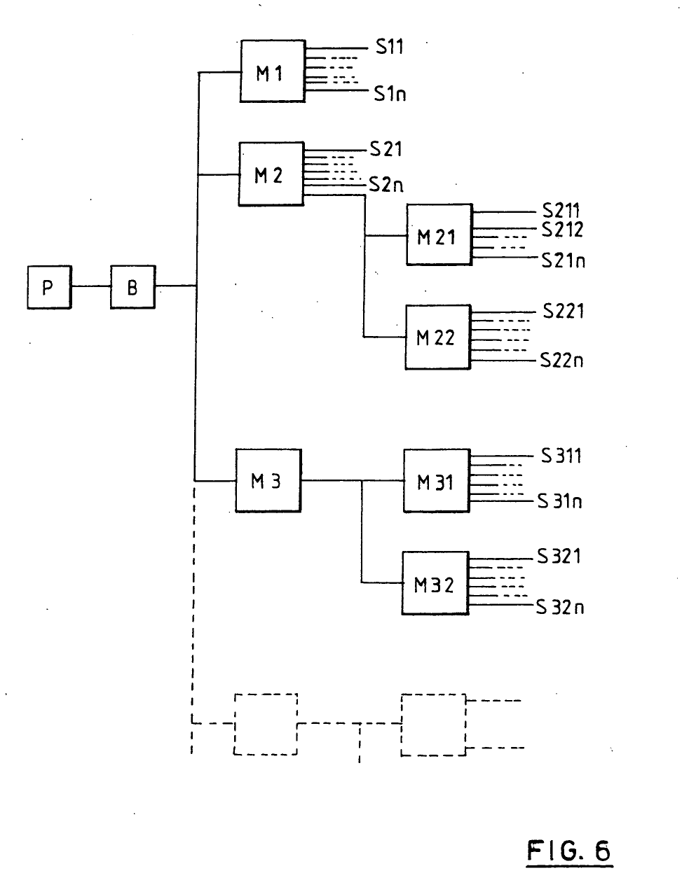

The present invention may be applied at each node in a complex network, such as in a fan-out distribution as shown in FIG. 6. Events are disseminated from publisher P to many subscribers. Publisher P distributes to publishing broker B which distributes to machines M1, M2, and M3. M1 is a ‘pure’ subscriber machine. M3 is a ‘pure’ intermediate gateway machine (for machines M21 and M22). M2 performs both subscriber endpoint and gateway functions. S11, . . . S1N are registered as subscribers with M1; S21, . . . S2N, M21 and M22 are registered with M2; M31 and M32 are registered as subscribers with M3; S211, . . . S21N are registered as subscribers at M21; S221, . . . S22N are registered at M22; S311, . . . S31N are registered with M31; and S321, . . . S32N are registered with M32, and so on.

Each intermediate node B, M1, M2, M3, M21, M22, M31, M32 may determine the method it wishes to use to send a message to its registered subscribers. In particular it may decide based on the number of its subscribers, whether to use the method of the present invention or to use another method. For example if there are a very small number of subscribers, it may be best to simply use a header including an ID for each of the subscribers. The publisher P may send events without any header to B. B may carry out matching or simply pass on the event, without carrying out any matching, to machines M1, M2 and M3. These machines may then carry out matching to see to which of their subscribers the event relates and produce an appropriate header.

Insofar as embodiments of the invention described are implementable, at least in part, using a software-controlled programmable processing device or, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disc or tape, optically or magneto-optically readable memory such as compact disk (CD) or Digital Versatile Disk (DVD) etc, and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

The method may also be carried out in computer hardware, for example on a network card.

It will be understood by those skilled in the art that, although the present invention has been described in relation to the preceding example embodiments, the invention is not limited thereto and that there are many possible variations and modifications which fall within the scope of the invention. For example, the ‘set’ bits in a signature could have either the value 1 or 0, and the fuzzy test could be such as to have only true positive results, with verification needing to be done for returns of a negative result. Also, allocation of signatures might not be done by the message sender, but instead be made by some other mechanism.

The scope of the present disclosure includes any novel feature or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

For the avoidance of doubt, the term “comprising”, as used herein throughout the description and claims is not to be construed as meaning “consisting only of”.

1. A method of delivering a published event to a subscriber, the subscriber having a signature bit pattern and one or more criterion for selecting a published event for processing, the method comprises the steps of:
receiving a message identifying an event and including an encoded set of subscriber signatures;
determining whether the encoded set of signatures corresponds correctly to the signature bit pattern of the subscriber;
dependent on the correspondence or not of the subscriber's signature bit pattern, verifying whether the event matches some or all of the selection criteria of the subscriber; and
if it matches, the subscriber processing the event.

2. A method according to claim 1, further comprising the step of one or more subscriber(s) registering one or more event selection criterion with a message sender.

3. A method according to claim 2, further comprising the step of the message sender allocating a signature bit pattern to each subscriber.

4. A method according to claim 2, further comprising the step of the message sender selecting those of its registered subscribers which have event selection criteria which match the event.

5. A method according to claim 4, wherein the message sender encodes the signatures of the selected subscribers to produce the encoded set of subscriber signatures.

6. A method according to claim 5, further comprising the step of the message sender sending the message to each of its registered subscribers.

7. A method according to claim 1, wherein the encoded set of signatures comprises a combination of the signature bit patterns of subscribers whose event selection criteria match the event.

8. A method according to claim 7, wherein the encoded set of signatures is a bit pattern with each bit being set if a corresponding bit in any of the signatures of the matching subscribers is also set.

9. A method according to claim 7, wherein the combination corresponds to the bitwise INCLUSIVE OR of the signature bit patterns of the matching subscribers.

10. A method according to claim 1, wherein the step of determining correspondence between the encoded set of signatures and the subscriber signature bit pattern comprises checking whether each bit set in the subscriber bit pattern is also set in the encoded set of signatures.

11. A method according to claim 3, wherein the number, N, of registered subscribers, is greater than the number of bits, M, in the subscriber signature bit patterns.

12. A method according to claim 1 wherein the number of bits in the encoded set of subscriber signatures is the same as the number of bits, M, in the subscriber signature bit pattern.

13. A message delivery mechanism for a system comprising a plurality of subscribers each having a signature bit pattern and one or more criterion for selecting a published event for processing, the mechanism being operable to:
receive a message identifying an event and an encoded set of subscriber signatures;
determine whether the encoded set of signatures corresponds correctly to the signature bit pattern of one or more subscribers;
dependent on the correspondence or not of the encoded set and the signature bit pattern of a subscriber, verify whether the event matches some or all of the selection criteria of the relevant subscriber; and
if it matches, the subscriber processing the event.

14. An event publishing mechanism for a system comprising a plurality of subscribers each having a signature bit pattern and one or more criterion for selecting a published event for processing, the mechanism being operable to:
select those subscribers for which the event matches some or all event selection criterion;
combine the set of signature bit patterns of the selected subscribers into an encoded signature set; and
send a message to the subscribers, the message identifying the event and the encoded signature set.

15. A mechanism according to claim 14, further operable to allocate a signature bit pattern to each subscriber.

16. A program element comprising program code operable to provide the message delivery mechanism according to claim 13.

17. A program element according to claim 16 on a carrier medium.

18. A carrier medium comprising a computer program element including computer program instructions to implement the method of claim 1.

19. The carrier medium of claim 18, comprising one or more of the following set of media: a signal, a magnetic disk or tape, solid-state memory, a compact disk and a digital versatile disk.

20. A data processing system comprising a message delivery mechanism according to claim 13.

21. A program element comprising program code operable to provide the event publishing mechanism of claim 14.

22. A data processing system comprising an event publishing mechanism according to claim 14.
